(19) United States
(12) Patent Application Publication
(10) Pub. No.: US 2015/0038109 A1
(43) Pub. Date: Feb. 5, 2015

(54) EMERGENCY RESPONSE SYSTEM

(71) Applicant: Chad Salahshour, Gates Mills, OH (US)

(72) Inventor: Chad Salahshour, Gates Mills, OH (US)

(21) Appl. No.: 14/450,549

(22) Filed: Aug. 4, 2014

Related U.S. Application Data
(60) Provisional application No. 61/861,547, filed on Aug. 2, 2013.

(51) Int. Cl. H04W 4/22; H04W 4/02

(52) U.S. Cl. CPC H04W 4/22; H04W 4/025; H04W 4/021
USPC 455/404.2; 455/404.1

(57) ABSTRACT

Methods and systems are provided for receiving requests for one or more types of emergency response services. A request for emergency services is initiated using a mobile application, and the request is transmitted to a dispatch service that notifies the emergency response organization of the request. The location at which the request for emergency services is made can be determined, communicated to the emergency response organization via the dispatch service, and the location of a request can be used in connection with a geo-fence to determine which public safety organization receives notice of the request. Information regarding a user can be stored and then included with a request for emergency response services. The mobile app includes the ability for a user to make community police reports that include text, pictures and video, and the mobile app can be provided to stream audio and video in connection with a request for emergency services. The dispatch service may be configured to send notifications to some or all users of the mobile app.

### RELATED APPLICATION

This application claims the benefit of U.S. Provisional Application 61/861,547 entitled Emergency Response System, filed on Aug. 2, 2013, and incorporated by reference as if fully rewritten herein.

### TECHNICAL FIELD

The inventions described herein relate generally to emergency response systems and more specifically to systems and methods for receiving, recording, maintaining and distributing emergency requests and response information.

### BACKGROUND

In 1968 the residents of Haleyville, Ala. became first in the nation to have an active 911 emergency response system. But since its inception, 911 and the emergency response sector have been slow to evolve. For example, emergency dispatchers did not have the technical ability to view a caller's location until 1998, and only then if the person was calling from a landline.

Recently, mobile cell phones have become the primary means of communication in society. While many emergency systems and Public Safety Answering Points (PSAP) are able to determine a caller's location from a landline, they are often unable to obtain sufficiently-accurate location information for service calls made from mobile phones. This is hugely significant in today's mobile world as, according to the FCC, over 70% of emergency calls are now being made via cell phone.

In addition to lacking the ability to determine a caller's location from a cell phone, many emergency response systems and PSAPs are not able to determine other critical details from a caller. Often times, emergency calls are cut short or the caller is unable to provide all the necessary information to the operator. Current systems are not configured to allow alternative means for the caller to provide other critical details of the emergency situation, such as medical data, pictures and other data.

Therefore, for at least these and the additional reasons disclosed herein, the need exists for an improved emergency response system.

### SUMMARY

This summary is provided to introduce a selection of concepts in a simplified form that are further described below in the Detailed Description. This Summary is not intended to identify key or essential features of the claimed subject matter, nor is it intended to limit the scope of the claimed subject matter.

An emergency response system is generally provided. The response system includes a software package that provides tools for law enforcement professions and ordinary citizens that address the above mentioned issues and more. The response system further may include mobile apps and a dispatch service, which may comprise a secure cloud based web-service. The mobile apps can be downloaded by a user using a smartphone or other network-enabled device and can be used to initiate a request for emergency services. Emergency response requests may be made from the mobile and other devices and the information may be transmitted, stored and provided to public safety organizations using the dispatch. The mobile application may provide location information and other critical details of the emergency situation to the dispatch service.

### DESCRIPTION OF THE DRAWINGS

FIG. 1 illustrates a system overview of an emergency response system.

FIG. 2 illustrates a screenshot of input buttons on a mobile phone application.

FIG. 3 illustrates an embodiment of a geo-fence.

FIG. 4 illustrates a map showing a geo-fence area.

FIG. 5 illustrates a dispatch central tab screenshot.

FIG. 6 illustrates a master map screenshot.

FIG. 7 illustrates a dispatch central tab with a view of a live incident.

FIG. 8 illustrates a screenshot of a user profile.

FIG. 9 illustrates a screenshot of a location report.

FIG. 10 illustrates a screenshot of a dispatch page with a unit on the scene.

FIG. 11 illustrates a screenshot of a report tab on a mobile device.

FIG. 12 illustrates a screenshot of a report tab with the accordions closed.

FIG. 13 illustrates a screenshot of an iReport.

FIG. 14 illustrates a screenshot of a push notification on a mobile device.

FIG. 15 illustrates a screenshot of the messaging platform.

FIG. 16 illustrates a screenshot of a crime analytics report page.

FIG. 17 illustrates a diagram of a communication gap scenario.

FIG. 18 illustrates a diagram of teacher link communication.

FIG. 19 illustrates a screenshot of a teacher-talk interface.

### DETAILED DESCRIPTION

Reference will now be made in detail to exemplary embodiments of the present invention, examples of which are illustrated in the accompanying figures. Other embodiments may be utilized and structural and functional changes may be made without departing from the respective scope of the invention. Moreover, features of the various embodiments may be combined or altered without departing from the scope of the invention. As such, the following description is presented by way of illustration only and should not limit in any way the various alternatives and modifications that may be made to the illustrated embodiments and still be within the spirit and scope of the invention.

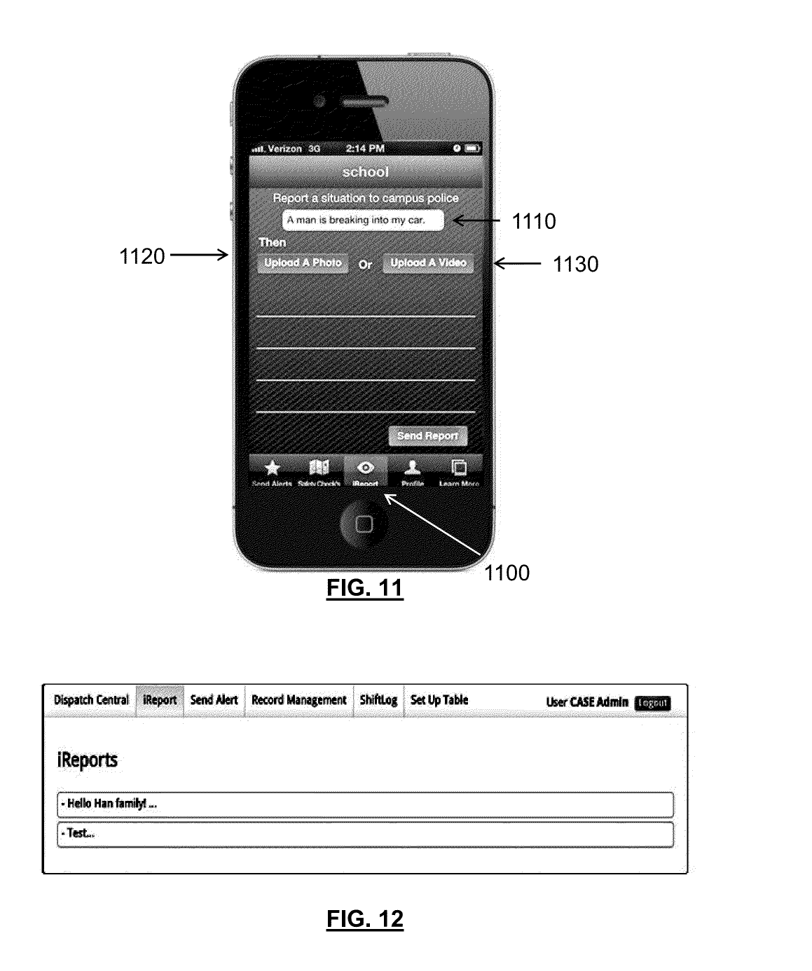

An emergency response system and components and related software applications generally shown in FIGS. 1-22. The system generally comprises a dispatch utility and service and a mobile application, or “mobile app,” which can be implemented as a stand-alone app that is downloaded using a smartphone or other mobile computing device, as a web app using, for example, HTML5, as software that is installed on a computing device such as a PC or laptop computer, or in other ways that will be known to those of ordinary skill in the art. The dispatch service may, but does not necessarily, comprise a software program or programs, such as a web-based software program configured to run on a server and provide a web-based utility service, and may be implemented using a secure cloud-based service or using servers hosted by or on behalf of a public safety organization. The mobile app. may be configured to interface with the dispatch service to report and communicate information to members of the public safety organization, as further described below.

FIG. 1 illustrates a general system overview for emergency response system 100. The system contains new and much needed tools for emergency service organizations, including law enforcement and other service providers, that address the above mentioned issues and more. As illustrated, emergency response system 100 includes a mobile app no, which is made available to users, who may be students, teachers, residents, employees and others who may request service from the relevant public safety force. In one embodiment, mobile app 110 is configured to interface and wirelessly communicate with dispatch service 120, which is controlled and monitored by public safety organization 130. Members of public safety organization 130 can access information within dispatch service no using unique login credentials.

In the event of an emergency or other need for assistance, a user can request service using mobile app 110. Mobile app 110 will then send a request for service 140 to dispatch service 120. Upon receipt of a request for service 140, dispatch service 120 will notify members of public safety organization 130, who can access information relating to request 140 through access to dispatch service 120 and can respond to request for service 140 accordingly.

Public safety organization 130 may be provided with a secure login credentials to access the dispatch controls and other information within dispatch service no. Where dispatch service 120 is implemented as a web service, whether locally or via the internet, public safety organization 130 may be provided a unique URL and an initial username and password to gain access to dispatch server 120. Once logged in, members of public safety organization 130 are able to view live incidents and other information in put into the system by way of one or more requests for service 140, dispatch units, send mass notifications, administer the service, and perform other functions.

Public safety organizations, including law enforcement agencies, can make available emergency response system 100 to potential users within their jurisdiction through mobile app 110. After receiving access to mobile app 110, users may be required to provide certain identifying profile and other information, such as name, photo, allergies, medications, blood type, primary care doctor's name and phone number, emergency contacts, insurance provider, and other information. Mobile app 110 may be specifically designed or configured to be used by safety forces at universities, municipalities, hospitals, large companies, K-12 school districts, parks and the like. Dispatch service 120 may be configured to accept “plug-ins,” giving end-users the ability to customize the specific feature set that their department wishes to deploy. The features selected on the dispatch service may be reflected in the mobile app and dispatch service functionality. Therefore, system 100 may be changed and updated as new features become available.

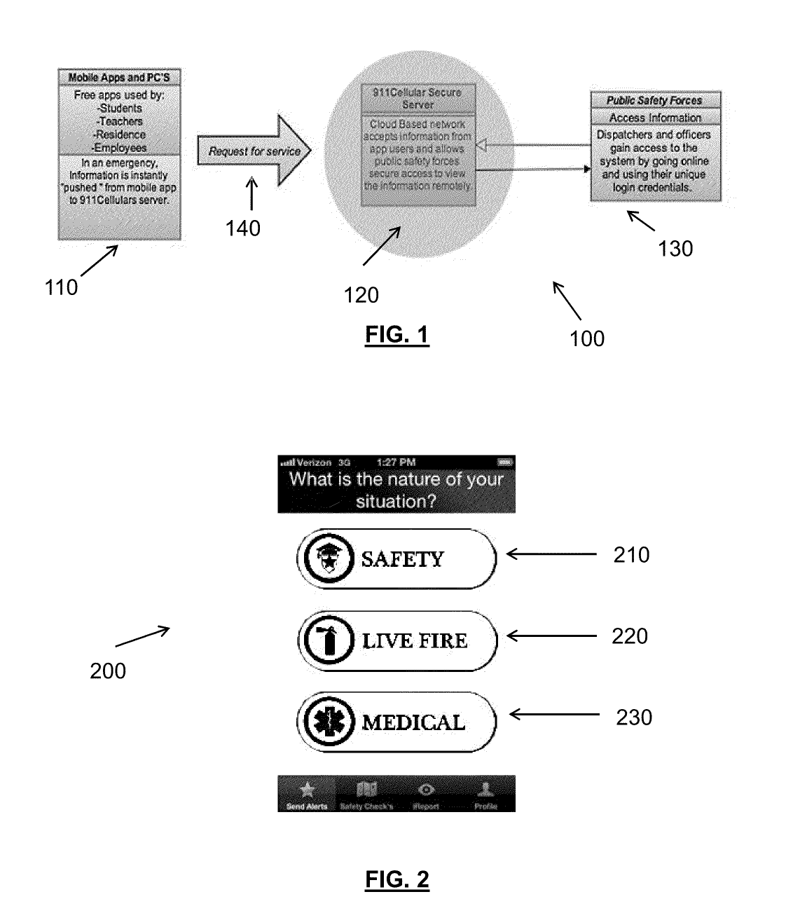

As shown by exemplary screen shot 200 in FIG. 2, mobile app 110 may allow users to have direct communication with the dispatch service and, accordingly, the public safety organizations. Such direct communication may be facilitated by pressing a single on-screen button within mobile app 110. Mobile app. no also may provide for direct communication of the type of service needed. For example, a user may communicate a need for safety services by pressing on-screen button 210, report a live fire by pressing on-screen button 220 or request medical attention by pressing on-screen button 230. Upon a user pressing on-screen button 210-230, mobile app 110 will cause a request for service 130 to be sent to dispatch server no, thereby communicating to the relevant public safety organization both the request for service and, where applicable, the type of service (e.g., safety, fire or medical) being requested and other pertinent information.

Emergency response system 100 may be used to supplement, replace or improve current systems for contacting emergency services. For example, safety posts are a fixture on many campuses. The safety posts are physical, unmovable outposts where a person can press a button to contact a public safety organization by, for example, initiating a 9-1-1 call (or its equivalent) or through a direct connection to a public safety organization. Many of these posts have a blue light attached to the top, leading to the nickname “blue lights.” Blue lights, however, are limited in their effectiveness because they fail to account for a number of factors, including the psychology of a victim during an altercation. For example, it's likely that someone in a high stress situation will not necessarily think clearly enough to locate a blue light, get close enough to press the button and then wait for help. In fact, these “safety” mechanisms are actually dangerous because, in many situations, a victim should not remain in the area of the attacker if at all possible. Furthermore, because “blue lights” require hardware, maintenance and a constant communication connection, they are expensive and require difficult choices regarding where they should be placed. The emergency response system disclosed herein addresses these issues by allowing users to contact emergency services from anywhere on served by the applicable public safety organization.

One feature of mobile app 110 is to act as a mobile or virtual version of a “blue light” by allowing users to use the app to activate a panic button. In one embodiment, mobile app 110 is configured to provide emergency responders information regarding the user's location as part of request for service 130 regardless of where the user is located instead of relaying on the fixed, predetermined location of a “blue light” for determining the location of where the request was made. When a user presses one of buttons 210-230 shown in FIG. 2, mobile app 110 begins updating the location of the user using GPS services or other available methods to determine with reasonable accuracy the location or coordinates of the user at the time of the request and on a going-forward basis. Mobile app 110 can then include information regarding the determined location as part of a request for service 130.

Location information also can be used in connection with geo-fences defined by a public safety organization for routing service requests made from specific locations. A public safety organization define one or more geo-fences. The geo-fences may be pre-assigned based on existing borders and boundaries, such as campus areas and jurisdictional borders, or any other delineation desired by the public safety organization. When using a geo-fence, mobile app 110, either alone or in communication with dispatch service 120, determines the user's current location and then compares the coordinates (x, y) to the coordinates of the boundaries of the geo-fences.

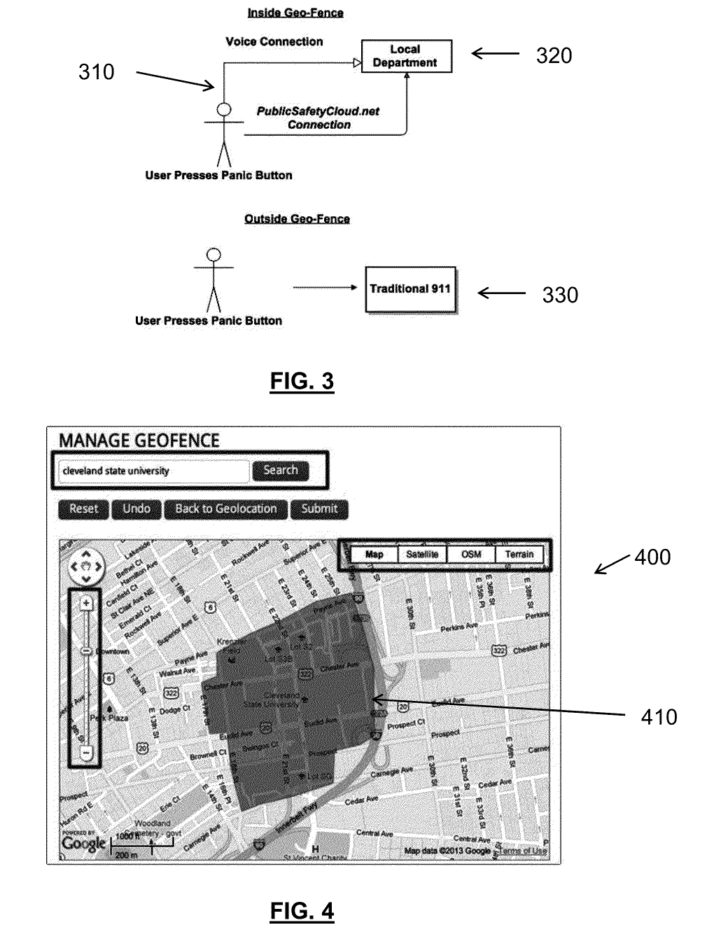

FIG. 3 illustrates one way that a request for service 140 may be handled depending on whether the request was made from a location determined to be within or outside of a defined geo-fence. If the user making the request is located within a geo-fence, mobile app 110 may send a request for service 130 that causes dispatch service no to bypass the traditional 9-1-1 systems and instead a direct voice connection 310 may be established with a predetermined call center, such as the appropriate jurisdiction's police or campus law enforcement (identified as local department 320), while simultaneously sending pertinent location information and profile details 330 to local department 320. If, however, the user is outside of a geo-fence, mobile app 110 and dispatch service 120 may be configured to initiate a direct voice connection to traditional 9-1-1 services 330, who will then to contact the appropriate emergency response personnel.

FIG. 4 illustrates a map 400 showing an embodiment of a geo-fenced area 410. When a public safety organization defines an area as being geo-fenced, emergency response system 100 collect thousands of (x, y) coordinate data points within the geo-fenced area and compile them in a database. Then, when a panic button is pressed from mobile app 110, the current location can be compared to geo-fenced area by mobile app 110, dispatch service 120 or a combination thereof. As mentioned, if a user presses a panic button from within the geo-fence, mobile app 110 or dispatch service 120 may initiate a voice call to a determined public safety organization and location and other information may simultaneously be communicated using dispatch service 120. Thus, in one embodiment, when a user activates the panic button in mobile app 110 from within a geo-fence, the relevant public safety forces organization will not only receive a voice call, it will also have access critical information about the caller through dispatch service 120.

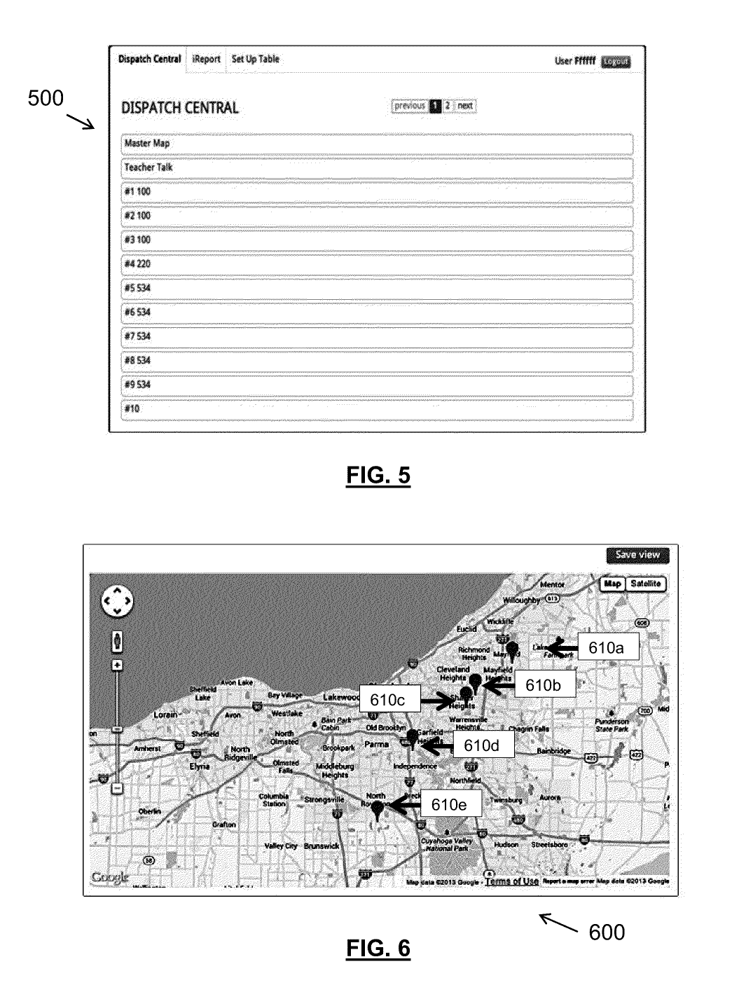

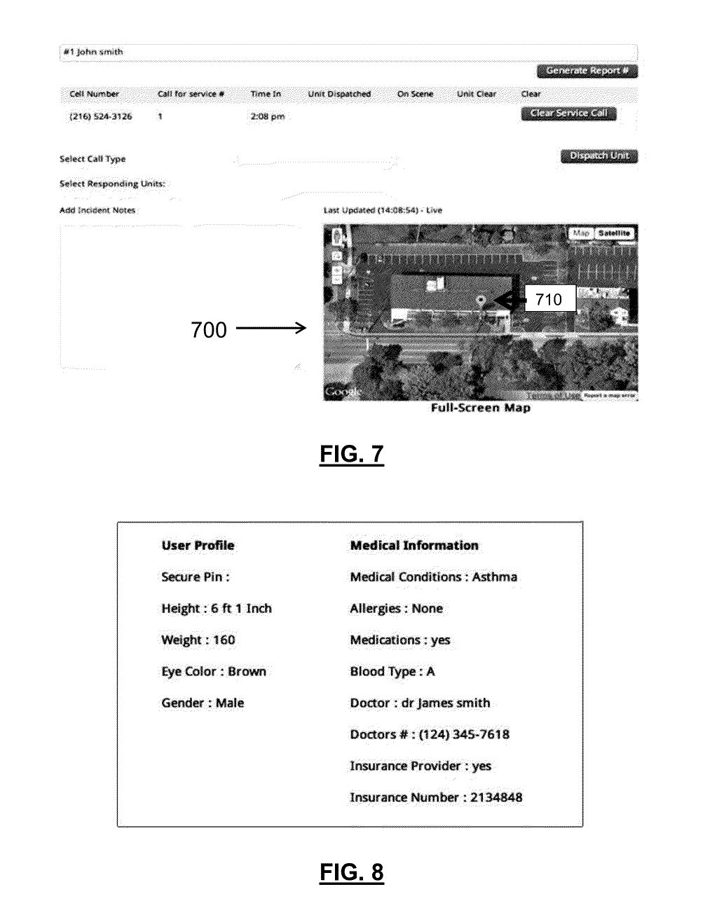

Dispatch service 120 may provide for a centralized location for reporting panic button activations to be displayed. In one embodiment, such information is reported in a single screen, shown as “Dispatch Central” tab 500 in FIG. 5. In one embodiment, Dispatch Central tab 600 is structured in accordion format, coded so the most recent service request automatically appears in the first position. This allows significant quantities of information to be displayed on one single page, resulting in an easy-to-use format. When an app user requests service from within a geo-fence, Dispatch Central tab 500 can be configured to display a user's location, profile information, photo, any emergency contacts and other information that allows dispatchers to perform vital response functions, such as assign units and report numbers. In one embodiment, relevant maps may be provided, including a general map of an entire area 600, as shown in FIG. 6 and referred to as a “master map,” and a more detailed map 700, as shown in FIG. 7 and referred to as the “individual map.”

In one embodiment, master map 600 displays active service requests made within in a defined area in a single, simple-to-view area. Master map 600 also may be configured to display the location of active officers to help dispatchers identify which are closest to the reported location of a request. Master map 600 also can allow public safety forces to identify the locations of recent events, including other reports and recent crimes, occurring within the area by placing visual markers (sometimes referred to as “dropping pins”) 610a-e on the map at the relevant locations. Pins 610a-e may be made visible to users of mobile app 110 if the public safety force desires.

Individual map 700 similarly may include a visual marker (or “pin”) 710 to denote the location of a user who has requested service. Individual map 700 may be configured to update the location of the user at set increments, such as every 20 seconds, to help ensure dispatchers are viewing current locations. These updates may continue for a pre-determined interval (such as 1 hour), until the service call is cleared or the app user deactivates the request, whichever comes first. Dispatchers also may be able to view a full screen map and driving directions by pressing a “Full-Screen Map” or other similar button. Dispatchers may also be provided profile details the app user entered during registration. As shown in FIG. 8, such profile information may be displayed below or in connection with individual map 700, and may includes a user's photo, allergies, medications, blood type, primary care doctor's name and number, emergency contacts, insurance provider, and other information.

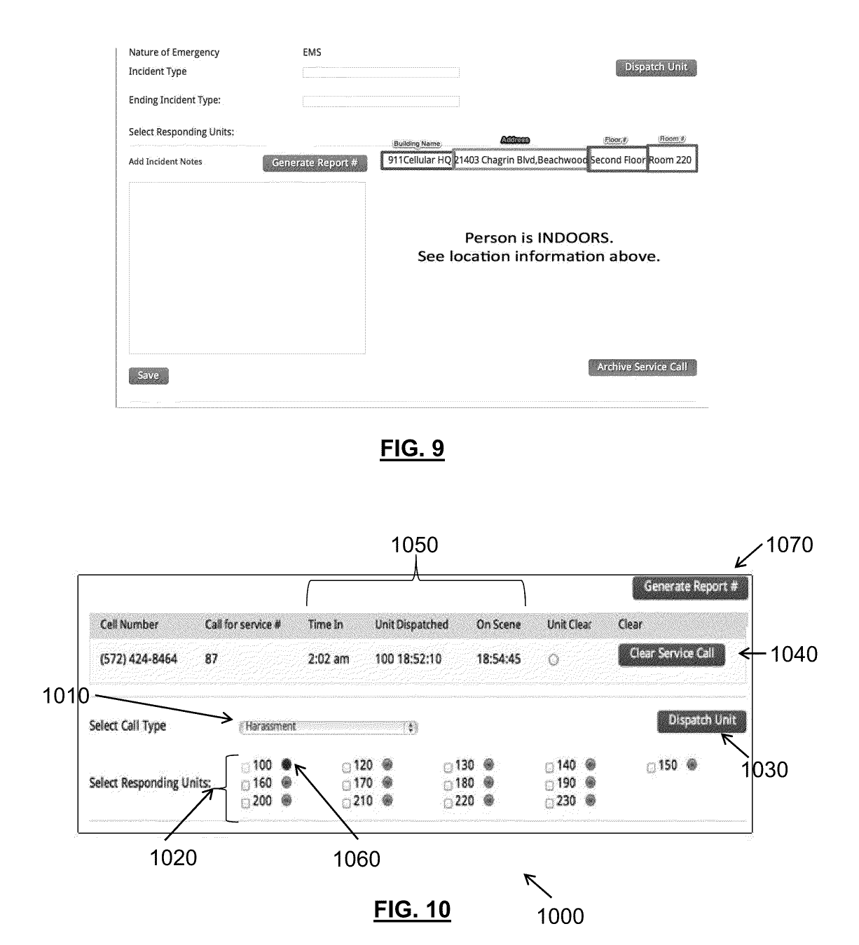

Emergency response system 100 may include the ability to identify and provide location information indoors, where GPS services may be ineffective to help emergency responders to locate a user within a building within a given proximity. For example, mobile app 110 may be able to use Wi-Fi access points at an organization as location “nodes” to help pinpoint the floor and room number of a service call from within a building. This can be accomplished by associating a set of descriptions (which may include coordinates and other pertinent information) to a WI-FI node and by measuring the signal strength of the WI-FI node at the location of device running mobile app 110 that was used to activate the panic button to calculate distance from the node and other metrics. This location can then be reported using dispatch service 120, as shown in FIG. 9. Indoor location information also can be reported by dispatch service 120 by overlaying information onto a pre-saved map of the building in the appropriate location.

Emergency response system 100 may include additional features to help dispatch emergency units and track the progress of a task. In embodiment 1100 shown in FIG. 10, dispatch service 120 may be used to dispatch response units by assigning a request an incident type 1010, then clicking a checkbox 1020 next to the unit that is to be dispatched, and confirming with “Dispatch Unit” button 1030. Once the units are dispatched, the selected units will appear in “dispatch status” area 1040, and one or more timestamps 1050 may be recorded and shown. A visual indicator 1060 next to the unit associated with checkbox 1020 can be provided to signify that the units status has been changed from “available” to “in-route” by, for example, changing from green to orange. In one embodiment, officers who are logged in as the assigned unit(s) are then provided the service request information and are able to view it in the field. The assigned officers also may be provided with the ability to input incident reports, including remotely from a laptop, tablet or other device. Emergency response system 100 also can be configured so that, when an officer radios in to confirm he/she is on scene, a dispatcher only needs to click the “on-scene” button to create a timestamp and to change the officers status. Emergency response system 100 may allow report numbers to be generated for each incident. In one embodiment, a report number can be generated by clicking a “Generate Report #” button 1070 and the report number which is next in line, based on the “report # setup,” will appear in-place-of the button.

Emergency response system 100 may provide for various additional advantages over traditional and current safety solutions, especially for local area and campus law enforcement. For example, traditional 911 systems direct calls to a countywide (or other regionally-defined) dispatch center, which must filter all such information to the appropriate local law enforcement groups, which can often create time and communication delays. Emergency response system 100 can help minimize those delays by utilizing GPS triangulation, geo-fencing and other location-finding technologies to determine which department should receive the call and placing the call directly without involving the traditional 911 dispatch center. Another problem is that, with many 911 answering points, dispatchers are not provided accurate locations in service calls from cell phones. Accurate location information is critical in emergency response situations, where callers are often panicked and disoriented. With the correct WI-FI location infrastructure, emergency response system 100 can better pinpoint the location of an user of mobile app 110 to the exact floor and room, thus improving emergency response. Emergency response system 100 also can provide dispatchers important profile information, such as the distressed parties photo and medical history. Also, integrating dispatching functions integrated into dispatch service 120 helps ensure that dispatchers have ready access to critical information by, for example, limiting the need to flip back-and-forth between screens.

Emergency response system 100 may also facilitate and provide for new forms a community policing. Institutions of higher education have long been easy targets for criminals because of the large number of people and the generally naive student population. Knowing this, many university police departments are encouraging the community to be more active in reporting crime by circulating a “See something. Say something” message, which encourages students to call 911 if they witness a crime. Although well intended, programs such as “See something. Say something” have proved to be ineffective, particularly given that text messaging has become the dominant form of communication. Furthermore, even when students call 911 to report a crime, if the suspect flees before officials arrive, there is often no evidence to work with, and the trail goes cold.

Emergency response system 100 can be configured to include a community policing reporting feature (referred to as “iReports”) to facilitate “See something. Say something” community policing, as shown in FIG. n. Mobile app 110 may allow users to send photos and videos of reportable situations, along with a description, to public safety services. In one embodiment, the user can use community policing functionality 1100 within mobile app 110 to provide information such as a description of the situation 1110 and a photo 1120 or video 1130 of the situation. Mobile app 110 will then send the report, including description 1110 and photo 1120 or video 1130 if available, as a request for service 140 to dispatch service 120.

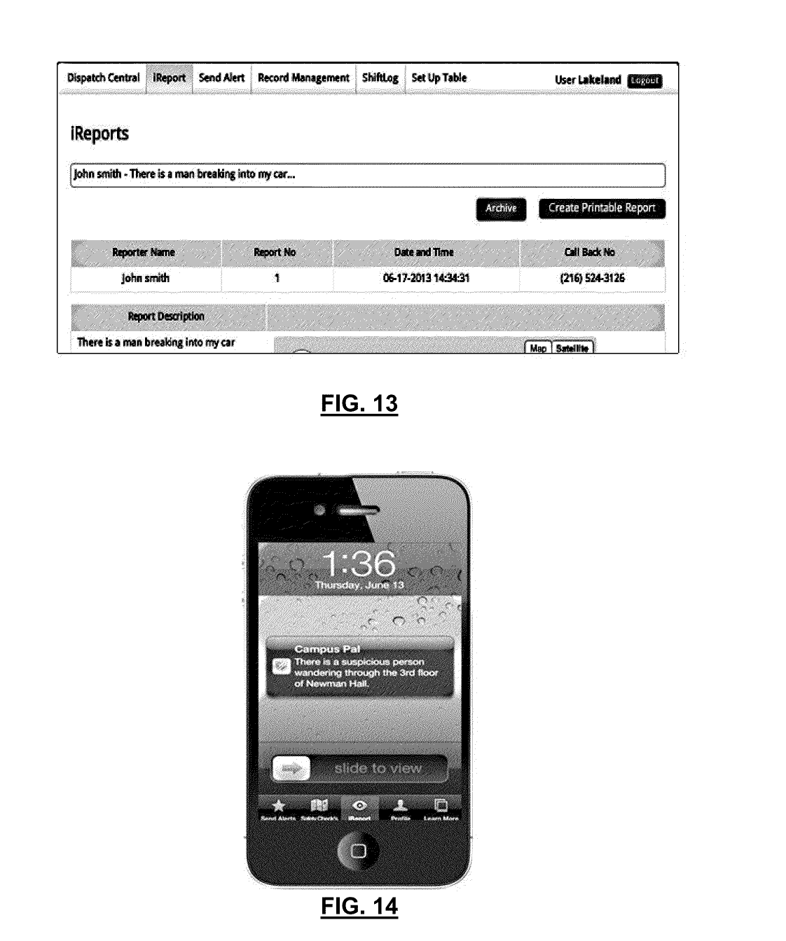

When a community policing report is made using system 100, functionality within dispatch service 120 can notify the public safety force of the report, for example through causing a tab containing all incoming reports to beep. The community policing tools in dispatch service 120, identified as the “iReports” tab in FIGS. 12 and 13, can be structured using an accordion format. When a community policing report is received, a member of the public safety organization can click on the accordion structure to reveal details about the report, which may include the reporter's name, a call back number, the photo or video file(s) attached, a map of the location, and a description of the event. Such reports can provide law enforcement with tangible evidence for police to use, and the reports may be converted into a pdf or other suitable file format for preserving and sending to other law enforcement departments.

Emergency response system 100 also may include a mass notification system. The mass notification system may include multiple methods to disseminate information using dispatch service 120. For example, dispatch service 120 may post information directly to social networking sites like Facebook, tweeted onto Twitter, send information as an email or text message, or send it as a push notification directly to a cell phone or other network-connected device. Push notification messaging is a form of communication that uses the internet to transmit information from the secure website directly to the home screen of a mobile device. The mass notification system also allows public safety forces choose specific recipients of an alert, so only those who need to know are sent the information. FIG. 14 illustrates an example push notification on a smartphone.

In one embodiment, a campus security service could take a photo received in an incoming community policing report, attach it to a notification, and then send the notification to the entire campus in the matter of seconds, making everyone aware of the criminal and his/her description. In one embodiment, dispatch service 120 may be configured to send push notifications to some, but not all, potential recipients based on a variety of criteria, including profile information, location data and user preferences. Furthermore, push notification messaging also allows users to choose specific recipients of an alert, so only those who need or want to know are sent the information.

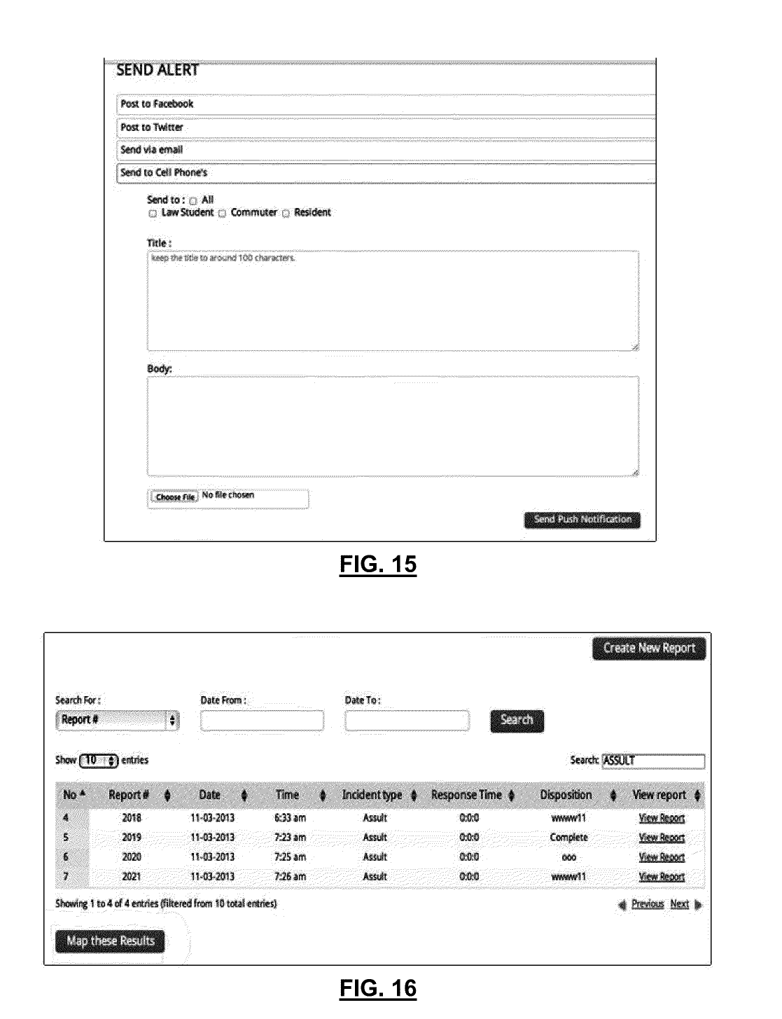

As previously mentioned, the emergency response system allows police departments to establish a connection to Twitter and Facebook so that important safety message can be sent to the general public quickly and efficiently. The email and text alerts allows the system to target specific groups. For example, a specific group of predetermined responders may be selected and sent email messages for a specific emergency task. FIG. 15 illustrates an example window for sending an email alert.

Unlike traditional mass notification systems, which require users to opt-into the system by visiting a website and manually entering ones personal information, emergency response system 100 can be required to simply require a user to download the mobile app, at which point the opt-in process can be automated for that user. A user also may be required to provide certain profile and other information before using mobile app 110. This may lead to a higher percentage of users and thus a wider reach. Further, other similar benefits stem from these features. For example, organizations may be able to segment the population in order to send customized messages to specific groups of users. Messages reach the home screen of a user's smartphone, not just their email box, which may not be checked as often. As well, integration allows for use without having to install hardware or jump back and forth between multiple browsers.

System 100 may include records management functionality. The records management functionality, shown as a tab in in FIG. 16, can be where all records are stored and where special crime analytics can be applied. Users of dispatch service 120 may be able to search through records based on unique identifiers such as service call number, report number, community policing reports and outbound alerts, and such users may be able to use keyword searching to narrow results even further. When searching by report number, a user may click a “Map These Results” or other similar button or selector to display a map of all or a subset of the search results.

Emergency response system 100 also may be configured to calculate and display crime analytics. These analytics allow users and organizations to actually use their reports to collect valuable data such as where a certain type of crime occurs or at what time. These analytics can be mapped to create digital charts for departments to use while making future preparations.

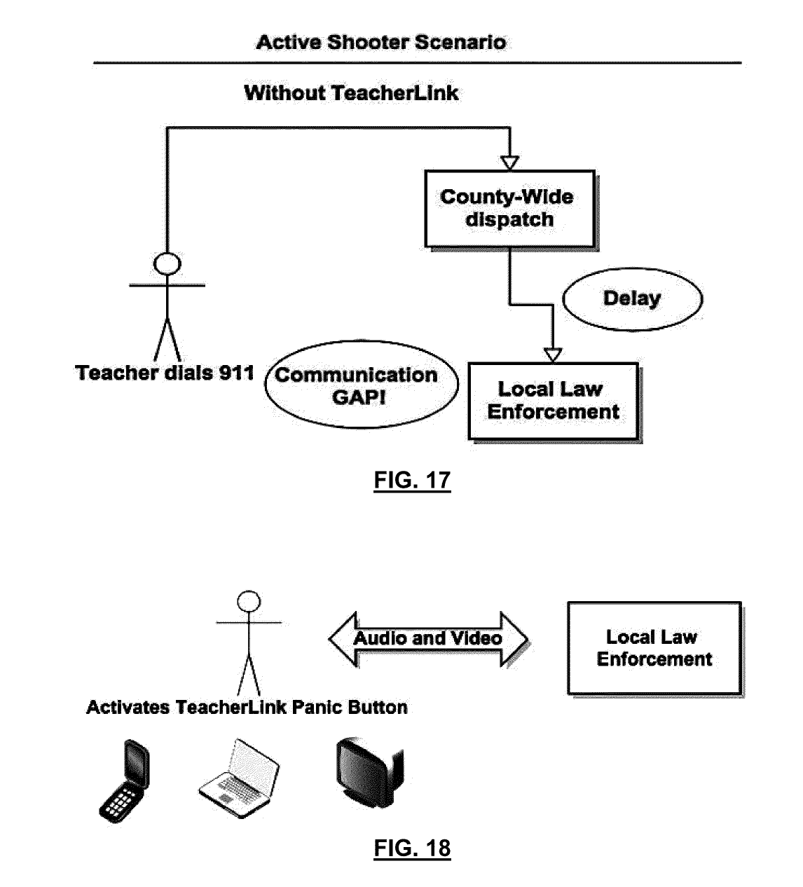

Emergency response system 100 also may be configured to provide specific functionality for different groups of intended users. For example, emergency response system 100 may be configured to provide features specifically designed to allow teachers to more effectively contact an emergency response organization and communicate during school emergency situations. Because of its redundant layers and single point of communication, current 911 infrastructure often is not adequate for school emergency situations, when seconds count. Not only does the current 911 system often create delays in communication, it can leave gaps in communication between those inside a school and those responding, as illustrated in FIG. 17. Emergency response system 100 can be configured to address these shortcomings to provide a dedicated communication tool to that facilitates a constant flow of important information throughout a school emergency. As shown in FIG. 18, emergency response system 100 can be configured to provide school faculty and staff (or any other users) using a mobile app or other computer software running on a variety of hardware platforms that includes a panic button for initiating a request for service to the public safety organization responsible for school-related emergencies. When a teacher activates the silent panic button, emergency response system 100 may be configured to automatically activate the audio and video capabilities of the device used to make the request (or other predetermined audio and video capabilities) and stream the audio and video feed to the public safety organization, who can then view the videos and panic activation details using the system.

Using emergency response system 100 in this way, public safety organizations are provided with critical information that they currently don't have access to, such as a live video of the classroom where a situation is active. Emergency response system 100 also can be configured to automatically displays the most recently activated video stream front and center, so officials can follow a situation without having to monitor multiple screens. Furthermore, standard protocol for active shooter situations requires that schools enter “lockdown” mode, but schools often are unable to quickly disseminating the lockdown message. Using emergency response system 100, a public safety organization can send a lockdown message to all the teachers, faculty and other persons to ensure that the lockdown message is more effectively disseminated.

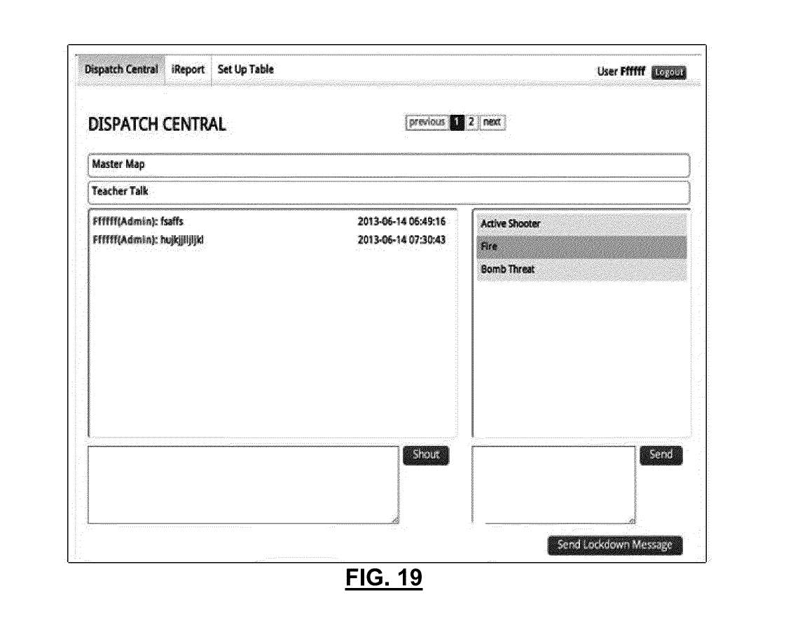

Thus configured, emergency response system 100 not only assists during the initial moments of a school emergency situation, it also provides faculty, staff and the police a common platform of communication throughout the event. For example, emergency response system 100 can be configured to include a chat feature that allows all parties to connect in a single forum through the internet, an example of which is shown in FIG. 19. Emergency response system 100 also may be configured for sending of pre-programmed messages, which may include auto-fill forms. These pre-programmed quick messages allow police to save valuable seconds while disseminating information.

Emergency response system 100 also may further include a discreet panic button that provides teachers and staff a line of communication directly to the law enforcement groups trained to respond to school related emergencies without making the criminal aware that help has been summoned. The panic button may provide emergency responders with a stream of live audio and video from the device, and a one-touch lockdown feature sends a pre-saved lockdown SMS or other form of electronically-communicated message to the entire faculty and staff, so everyone knows how to respond. The secure chat allows those in the school to communicate with the police throughout the entire emergency, so nobody gets left behind.

Various embodiments of the invention have been described above. Modifications, alterations, and/or combinations of the embodiments presented will occur to others upon the reading and understanding of this specification. The claims as follows are intended to include all modifications, alterations, and/or combinations insofar as they come within the scope of the claims or the equivalents thereof.

I claim:

1. A computer-implemented emergency response method, the method comprising:
providing a mobile app to a first user, said mobile app comprising a first on-screen button for said user to initiate a request for emergency services;
storing information regarding the first user;
communicating, by the mobile app, a first request for emergency services initiated by the first user;
receiving, by the dispatch service, the first request for emergency services;
notifying, automatically by the dispatch service, a first public safety organization of the first request for emergency services; and
providing, automatically by the dispatch service, stored information regarding the first user to the first public safety organization.

2. The computer-implemented emergency response method of claim 1, wherein the mobile app further comprises a second on-screen button, said first and second on-screen buttons being configured to request different types of emergency services, and identifying the type of emergency services being requested as a part of the first request for emergency services.

3. The computer-implemented emergency response method of claim 1, further comprising: determining the location at which the first user initiated the first request for emergency services and communicating said determined location as part of the first request for emergency services.

4. The computer-implemented emergency response method of claim 3, further comprising: associating a description with a wireless networking node and determining the location at which the first user initiated the first request for emergency services based, at least in part, on the signal strength of said node.

5. The computer-implemented emergency response method of claim 3, further comprising defining a geo-fence boundary and notifying, automatically by the dispatch service, a first public safety organization of the first request for emergency services only if the determined location is within a previously-defined geo-fence boundary.

6. The computer-implemented emergency response method of claim 5, wherein a second public safety organization is notified of the first request for emergency services if the determined location is outside of said geo-fence boundary.

7. The computer-implemented emergency response method of claim 3, further comprising: determining the location of the first user one or more times after the first request for emergency services and communicating said determined locations to the dispatch service.

8. The computer-implemented emergency response method of claim 1, further comprising: communicating by the mobile app to the dispatch service photographic, video or written information.

9. The computer-implemented emergency response method of claim 1, further comprising the first public safety organization sending, by the dispatch service, a first notification to the mobile app.

10. The computer-implemented emergency response method of claim 1, further comprising: communicating by the mobile app to the dispatch service a video or audio feed following a first request for emergency services.

11. A computer-implemented emergency response system comprising a mobile app for initiating and communicating a first request for emergency services, said mobile app comprising: a first on-screen button for initiating said request; a data store containing information regarding the first user; and a dispatch service for receiving the first request for emergency services, notifying a first public safety organization of the first request for emergency services, and providing the stored information regarding the first user to the first public safety organization.

12. The computer-implemented emergency response system of claim 11, wherein the mobile app further comprises a second on-screen button, said first and second on-screen buttons being configured to request different types of emergency services, and identifying the type of emergency services being requested as a part of the first request for emergency services.

13. The computer-implemented emergency response system of claim 11, further comprising a location service for determining the location at which the first request for emergency services is initiated and communicating said determined location as part of the first request for emergency services.

14. The computer-implemented emergency response system of claim 11, wherein a description is associated with a wireless networking node and the location service determines the location at which a first user initiated the first request for emergency services based, at least in part, on the signal strength of a wireless networking node.

15. The computer-implemented emergency response system of claim 13, wherein the dispatch service notifies the first public safety organization of the first request for emergency services only if the determined location is within a previously-defined geo-fence boundary.

16. The computer-implemented emergency response system of claim 14, wherein a the dispatch service notifies a second public safety organization of the first request for emergency services if the determined location is outside of said geo-fence boundary.

17. The computer-implemented emergency response system of claim 13, wherein the location service determines the location of the first user one or more times after the first request for emergency services and communicating said determined locations to the dispatch service.

18. The computer-implemented emergency response system of claim 11, wherein the mobile app communicates to the dispatch service photographic, video or written information with the first request for emergency services.

19. The computer-implemented emergency response system of claim 11, wherein the dispatch service sends a first notification to the mobile app.

20. The computer-implemented emergency response system of claim 11, wherein the mobile app communicates to the dispatch service a video or audio feed following a first request for emergency services.
